(19) United States
(12) Patent Application Publication
(10) Pub. No.: US 2018/0183709 A1
(43) Pub. Date: Jun. 28, 2018

(54) COMMUNICATION NODE, COMMUNICATION SYSTEM, COMMUNICATION METHOD, AND PROGRAM

(71) Applicant: NEC Corporation, Tokyo (JP)

(72) Inventor: Junichi TSUCHIYA, Tokyo (JP)

(73) Assignee: NEC Corporation, Tokyo (JP)

(21) Appl. No.: 15/848,174

(22) Filed: Dec. 20, 2017

(30) Foreign Application Priority Data
Dec. 28, 2016 (JP) 2016-254893

(51) Int. Cl. H04L 12/721; H04L 12/715; H04L 12/751; H04L 29/08; H04L 12/717

(52) U.S. Cl. CPC H04L 45/38; H04L 45/64; H04L 45/42; H04L 67/2814; H04L 45/02

(57) ABSTRACT

A communication node comprises a flow table that stores a flow entry defining how a packet is processed; a control part that updates the flow table according to an instruction from a predetermined control apparatus; a packet processing part that processes a received packet by referring to the flow table; and a control apparatus proxy part that creates a flow entry for realizing new communication in cooperation with control apparatus proxy parts of other communication nodes in place of the predetermined control apparatus when the new communication occurs in a state in which the instruction from the control apparatus cannot be received. The communication node sets the flow entry for realizing the new communication in the flow table and processes packets belonging to the new communication until an instruction from the predetermined control apparatus can be received.

### FIELD

### Reference to Related Application

The present invention is based upon and claims the benefit of the priority of Japanese patent application No. 2016-254893 filed on Dec. 28, 2016, the disclosure of which is incorporated herein in its entirety by reference thereto.

The present invention relates to a communication node, communication system, communication method, and program, and particularly to a communication node, communication system, communication method, and program that process a packet according to an instruction from a control apparatus.

### BACKGROUND

Patent Literature (PTL) 1 discloses a configuration in which, in a centralized control network such as OpenFlow, controllers that control switches provided in the network are hierarchically arranged.

PTL 2 discloses a configuration in which a hybrid controller that maintains the state of the entire network in a database 112 and updates the database 112 whenever any changes are made is provided, in addition to an SDN controller, in Software-Defined Networking (SDN) utilizing OpenFlow.

PTL 3 discloses a communication node comprising an autonomous operation part that refers to a second table in which an event is associated with a change applied to an entry stored in a flow table when the occurrence of the event is detected and that rewrites an entry in the flow table according to an event that has occurred on the switch side in the centralized-control-type network.

[PTL 1]

International Publication Number WO2014/133025A

[PTL 2]

Japanese Patent Kohyo Publication No. JP2016-521529A

[PTL3]

International Publication Number WO2014/175423A

### SUMMARY

The following analysis is given by the present invention. The centralized control network has a problem that, when a control apparatus referred to as OpenFlow controller or SDN controller cannot communicate with a switch or communication node, an appropriate flow entry cannot be set in the switch or communication node.

PTL 3 discloses the switch that refers to the second table configured in advance and rewrites a flow entry when the communication between a controller and the switch breaks down. The second table of PTL 3, however, only defines a change applied to an entry stored in the flow table when an event and the occurrence of the event are detected, and it is difficult for it to deal with new communication appropriately. Further, rewriting a flow entry will affect existing communication, depending on how the second table is configured.

It is an object of the present invention to provide a communication node, communication system, communication method, and program capable of establishing new communication and maintaining existing communication even when an instruction from a predetermined control apparatus cannot be received in the centralized control network.

According to a first aspect, there is provided a communication node comprising a flow table that stores a flow entry defining how a packet is processed, a control part that updates the flow table according to an instruction from a predetermined control apparatus, and a packet processing part that processes a received packet by referring to the flow table. Further, the communication node comprises a control apparatus proxy part that creates a flow entry for realizing new communication in cooperation with control apparatus proxy parts of other communication nodes in place of the predetermined control apparatus when the new communication occurs in a state in which the instruction from the control apparatus cannot be received. Further, the communication node sets the flow entry for realizing the new communication in the flow table and processes packets belonging to the new communication until an instruction from the predetermined control apparatus can be received.

According to a second aspect, there is provided a communication system including the communication nodes, and a control apparatus that instructs the plurality of communication nodes to update the flow tables.

According to a third aspect, there is provided a communication method including: having a communication node comprising a flow table that stores a flow entry defining how a packet is processed, a control part that updates the flow table according to an instruction from a predetermined control apparatus, and a packet processing part that processes a received packet by referring to the flow table detect that the instruction from the predetermined control apparatus cannot be received; and having the communication node create a flow entry for realizing new communication in cooperation with control apparatus proxy parts of other communication nodes in place of the predetermined control apparatus when the new communication occurs in a state in which the instruction from the control apparatus cannot be received, wherein the flow entry for realizing the new communication is set in the flow table so that packets belonging to the new communication can be processed until an instruction from the predetermined control apparatus can be received. The present method is tied to a specific machine, which is a communication node that processes a received packet by referring to a flow entry.

According to a fourth aspect, there is provided a program having a computer installed in a communication node comprising a flow table that stores a flow entry defining how a packet is processed, a control part that updates the flow table according to an instruction from a predetermined control apparatus, and a packet processing part that processes a received packet by referring to the flow table execute a process of detecting that the instruction from the predetermined control apparatus cannot be received; and a process of creating a flow entry for realizing new communication in cooperation with control apparatus proxy parts of other communication nodes in place of the predetermined control apparatus when the new communication occurs in a state in which the instruction from the control apparatus cannot be received. The program realizes a function of the communication node to set the flow entry for realizing the new communication in the flow table and process packets belonging to the new communication until an instruction from the predetermined control apparatus can be received. Further, this program can be stored in a computer-readable (non-transitory) storage medium. In other words, the present invention can be realized as a computer program product.

The meritorious effects of the present disclosure are summarized as follows. According to the present invention, it enables a controlled device, i.e., a communication node, to establish new communication and maintain existing communication even when an instruction from a predetermined control apparatus cannot be received in a centralized control network.

### BRIEF DESCRIPTION OF DRAWINGS

FIG. 1 is a drawing showing the configuration of an exemplary embodiment of the present disclosure.

FIG. 2 is a drawing for explaining the operation of an exemplary embodiment of the present disclosure.

FIG. 3 is a drawing showing the configuration of a communication system of a first exemplary embodiment of the present disclosure.

FIG. 4 is a drawing showing the configuration of an SDN switch of the first exemplary embodiment of the present disclosure.

FIG. 5 is a drawing for explaining VTN information held in an SDN controller of the first exemplary embodiment of the present disclosure.

FIG. 6 is a drawing for explaining VTN information held in the SDN switch of the first exemplary embodiment of the present disclosure.

FIG. 7 is a drawing showing an example of a flow entry created by the SDN switch of the first exemplary embodiment of the present disclosure.

FIG. 8 is a drawing showing flow entries set in a flow table of the SDN switch of the first exemplary embodiment of the present disclosure.

FIG. 9 is a flowchart showing the operation of the SDN switch of the first exemplary embodiment of the present disclosure.

FIG. 10 is a drawing showing a flow set by the SDN controller of the first exemplary embodiment of the present disclosure and a flow set by the SDN switch.

FIG. 11 is a flowchart showing an operation restoring the connection between the SDN switch and the SDN controller of the first exemplary embodiment of the present disclosure.

FIG. 12 is a flowchart showing another operation restoring the connection between the SDN switch and the SDN controller of the present disclosure.

### PREFERRED MODES

First, an exemplary embodiment of the present disclosure will be described with reference to the drawings. Note that drawing reference signs in the summary are given to each element as an example for convenience to facilitate understanding and are not intended to limit the present disclosure to the modes shown in the drawings. Further, connection lines between blocks in the drawings referred to in the description below can be both bidirectional and unidirectional. A one-way arrow schematically indicates the flow of a main signal (data) and does not exclude bidirectionality. Further, it is deemed to be disclosed, even when a part (input/output part) or interface be not explicitly mentioned at the connecting end(s) of a connecting line(s) connected to a functional member (part, block, unit or the like). Also, a line(s) is deemed as disclosed, even when such is omitted in the Drawing, which will become evident from entire disclosure. Generally, the computer includes at least one processor, and at least one memory (or storage device) and input/output interfaces.

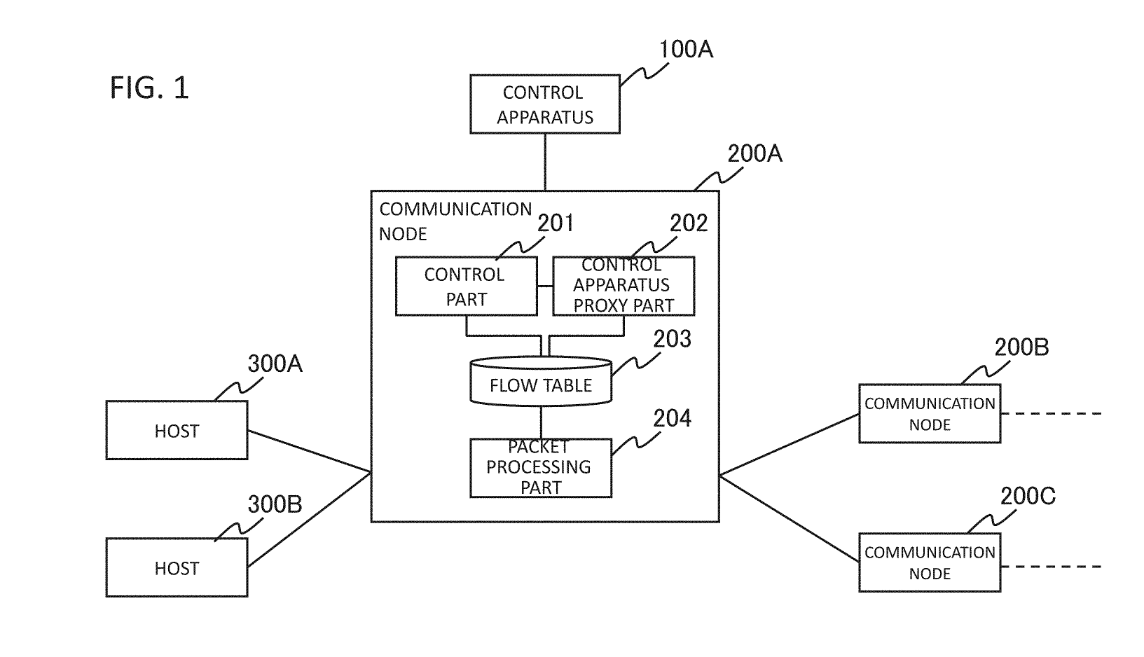

As shown in FIG. 1, the present disclosure in an exemplary embodiment can be realized by a communication node 200A that comprises a flow table 203, a control part 201, a packet processing part 204, and a control apparatus proxy part 202.

The basic functions of the communication node 200A can be the same as those of a forwarding node in a network having C/U separation. In other words, the flow table 203 stores a flow entry defining how a packet is processed. The control part 201 updates the flow table 203 according to an instruction from a predetermined control apparatus 100A. The packet processing part 204 processes a received packet by referring to the flow table 203.

When new communication occurs in a state in which the instruction from the predetermined control apparatus 100A cannot be received, the control apparatus proxy part 202 creates a flow entry for realizing the new communication in cooperation with control apparatus proxy parts of other communication nodes 200B and 200C, instead of the control apparatus 100A.

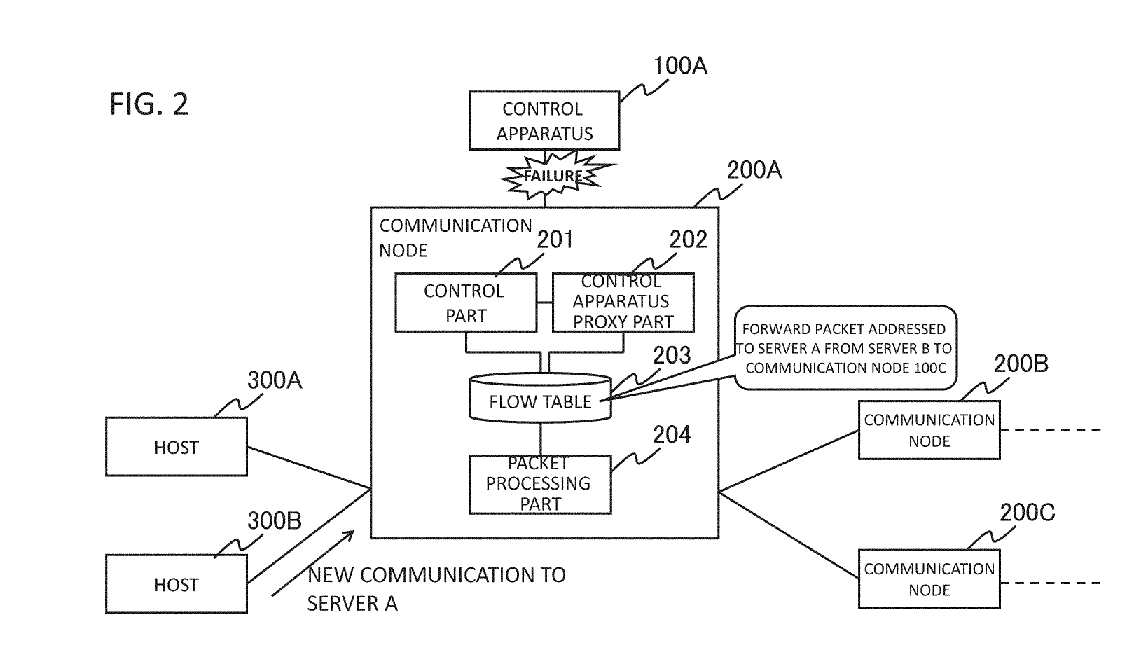

For instance, let's consider a case where the communication node 200A receives a packet addressed to a server A (not shown in the drawing) from a host 300B in a state in which a failure has occurred between the communication node 200A and the control apparatus 100A, as shown in FIG. 2. At this time, the control apparatus proxy part 202 of the communication node 200A creates a flow entry for forwarding the packet addressed to the server A (not shown in the drawing) from the host 300B to a communication node (for instance 200C). The communication node 200A sets the flow entry in the flow table 203 and processes new communication packets until it can receive an instruction from the predetermined control apparatus 100A.

The configuration above makes it possible to realize new communication even when a failure occurs between the communication node 200A and the control apparatus 100A. It goes without saying that existing communication can be maintained by keeping flow entries set by the communication apparatus 100A in the flow table 203.

### [Exemplary Embodiment 1]

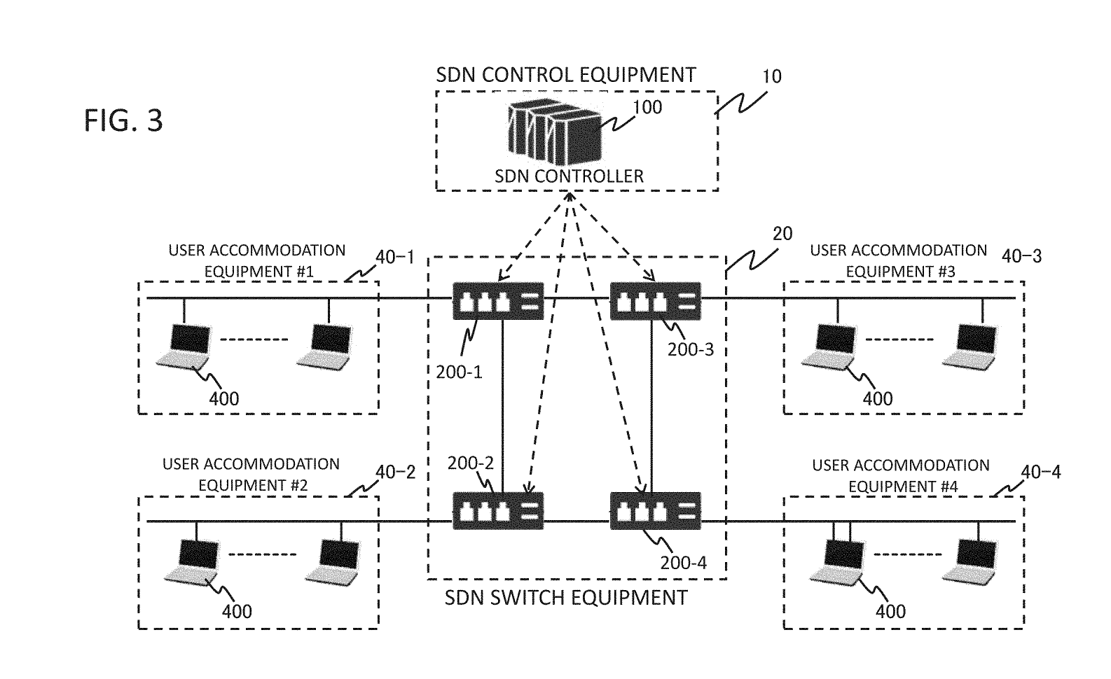

Next, a first exemplary embodiment of the present disclosure will be described in detail with reference to the drawings. FIG. 3 is a drawing showing the configuration of a communication system of the first exemplary embodiment of the present disclosure. FIG. 3 shows a configuration in which plural pieces of user accommodation equipment #1 to #4 (40-1 to 40-4) are connected via SDN switch equipment 20. Note that the number of the user accommodation equipment is not limited, although four pieces of user accommodation equipment are connected in the example of FIG. 3.

As SDN control equipment 10, an SDN controller 100 that controls SDN switches 200-1 to 200-4 provided as the SDN switch equipment 20 is provided. Note that the SDN controller may be constituted by a cluster of physical servers.

The SDN switches 200-1 to 200-4 (referred to as the “SDN switch 200” hereinafter when a specific SDN switch is not distinguished) are provided as the SDN switch equipment 20. Note that only one SDN switch may be provided or more than one switch, a plurality of them, may be provided as shown in FIG. 3.

The SDN control equipment 10 and the SDN switch equipment 20 are connected to each other via a control network (refer to dashed arrows in FIG. 3). Further, the SDN switch equipment 20 and the user accommodation equipment 40-1 to 40-4 are connected to each other via a user communication network (refer to solid lines in FIG. 3). Note that the control network and the user communication network may be constructed by the same physical network.

When communication occurs between user terminals 400, the SDN controller 100 receives a notification from the SDN switch 200, calculates an appropriate path, and sets control information (flow entry) for realizing the communication between the user terminals 400 in the SDN switches 200 on the path. Here, if a failure occurs in the network between the SDN switch 200 and the SDN controller 100, it will be difficult to set a flow entry addressing new communication between the user terminals 400. Therefore, the SDN switch 200 of the present exemplary embodiment is configured as follows.

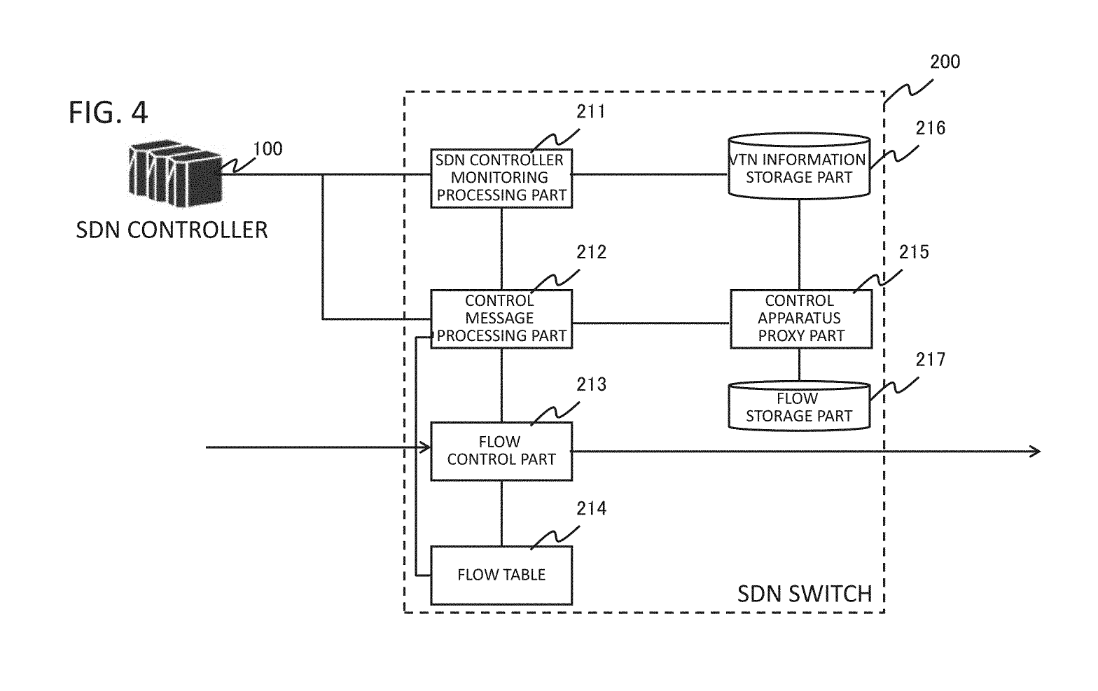

FIG. 4 is a drawing showing the configuration of the SDN switch of the first exemplary embodiment of the present disclosure. FIG. 4 shows a configuration comprising an SDN controller monitoring processing part 211, a control message processing part 212, a flow control part 213, a flow table 214, a control apparatus proxy part 215, a VTN information storage part 216, and a flow storage part 217.

The SDN controller monitoring processing part 211 monitors the connectivity with the SDN controller 100, i.e., whether or not an instruction from the SDN controller 100 can be received, and switches between the SDN controller 100 and the control apparatus proxy part 215 according to the monitoring result. Further, from VTN (Virtual Tenant Network) information held by the SDN controller 100, the SDN controller monitoring processing part 211 writes the information of a VTN to which the SDN switch belongs to the VTN information storage part 216.

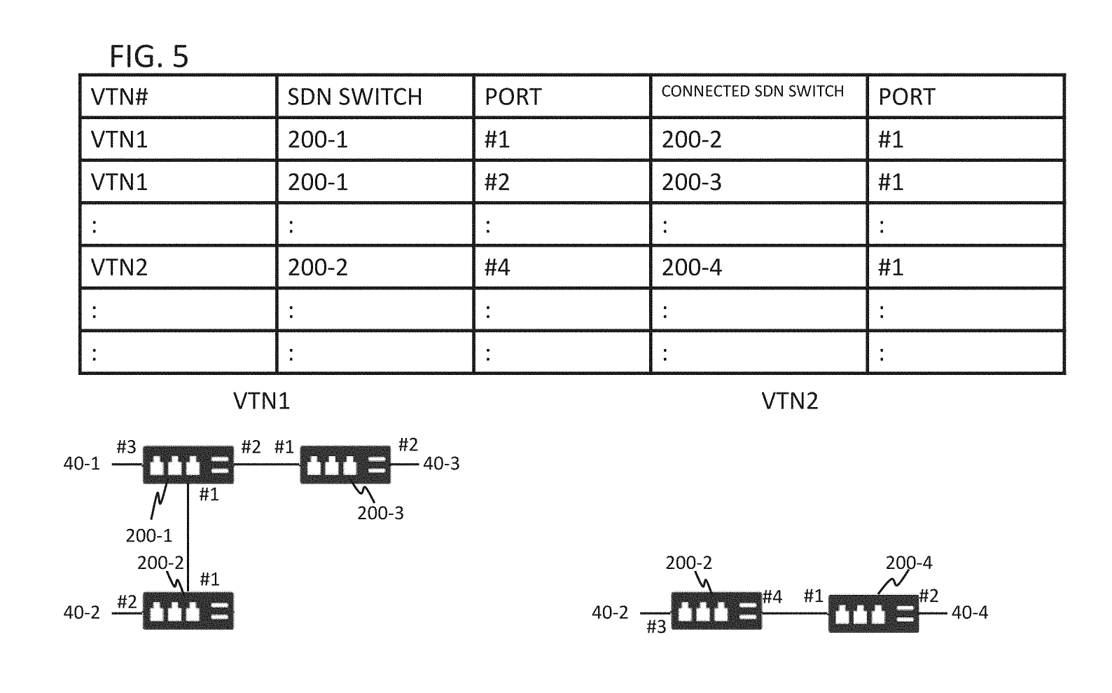

The table in the upper part of FIG. 5 shows an example of the VTN information held by the SDN controller. The example in FIG. 5 shows two kinds of VTNs: VTN1 and VTN2. Further, VTN1 is constituted by connecting a port #1 of the SDN switch 200-1 to a port #1 of the SDN switch 200-2 and a port #2 of the SDN switch 200-1 to a port #1 of the SDN switch 200-3. VTN2 is constituted by connecting a port #4 of the SDN switch 200-2 to a port #1 of the SDN switch 200-4. The lower part of FIG. 5 shows the configurations of VTN1 and VTN2 corresponding to the VTN information described.

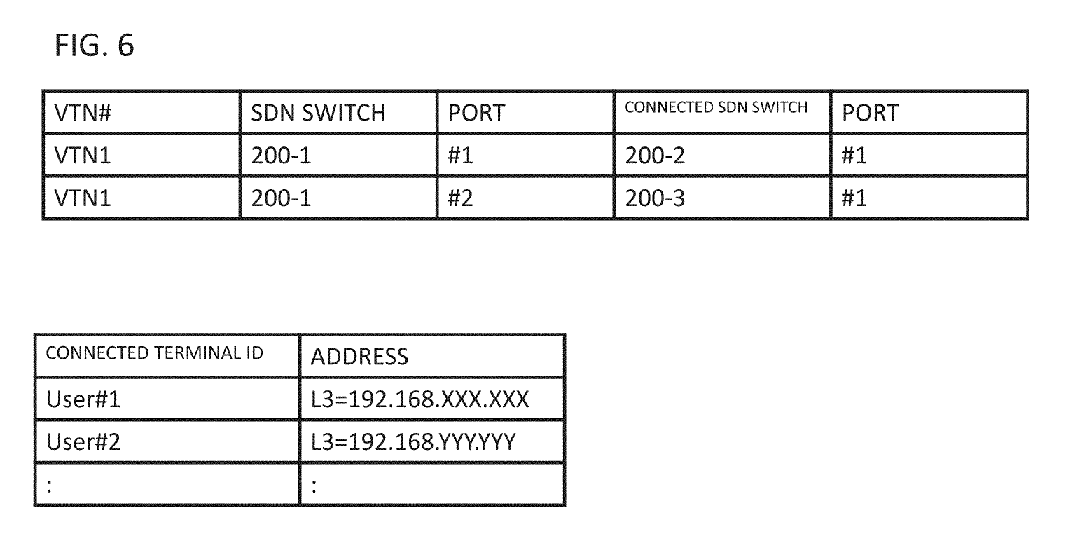

FIG. 6 is a drawing for explaining information held in the SDN switch 200-1 that has received the VTN information. As evident in FIG. 5, since the SDN switch 200-1 belongs only to VTN1, the VTN information of VTN1 is written to the VTN information storage part of the SDN switch 200-1. As described, by having each SDN switch hold only the information of the VTN to which it belongs, the size of the VTN information held by each SDN switch can be minimized. Further, IDs of users connected to the SDN switch 200-1 are associated with their addresses in the lower part of FIG. 6. The address information of each user terminal is stored in the address field. These addresses are used to create match fields.

The control message processing part 212 exchanges control messages with the SDN controller 100. For instance, upon receiving a flow entry to be stored in the flow table 214 from the SDN controller 100, the control message processing part 212 registers it in the flow table 214.

The flow control part 213 takes out a flow entry having a match condition that matches a received packet from the flow table 214 and processes the packet according to its contents. For instance, the flow control part 213 refers to the header of a received packet, finds a flow entry corresponding to a packet addressed to the user terminal 400 in the user accommodation equipment 40-2 from the user terminal 400 in the user accommodation equipment 40-1, and forwards the packet to the SDN switch 200-3 according to its contents. When the flow table 214 does not have a flow entry corresponding to the received packet, the flow control part 213 requests the SDN controller 100 or the control apparatus proxy part 215 to create a flow entry.

The control apparatus proxy part 215 operates in place of the SDN controller 100 when the SDN controller monitoring processing part 211 detects an abnormality in the connection with the SDN controller 100. Specifically, the control apparatus proxy part 215 creates a flow entry in place of the SDN controller 100 when receiving a request to create a flow entry from the flow control part 213.

More concretely, the control apparatus proxy part 215 creates a flow entry based on the information of the packet, for which the flow entry is created, received from the flow control part 213. The control apparatus proxy part 215 writes information for identifying the created flow entry to the flow storage part 217. Further, the control apparatus proxy part 215 writes the flow entry to the flow table 214 via the control message processing part 212. The control apparatus proxy part 215 notifies the adjacent SDN switches 200-2 and 200-3 of the information of the packet for which the flow entry is created.

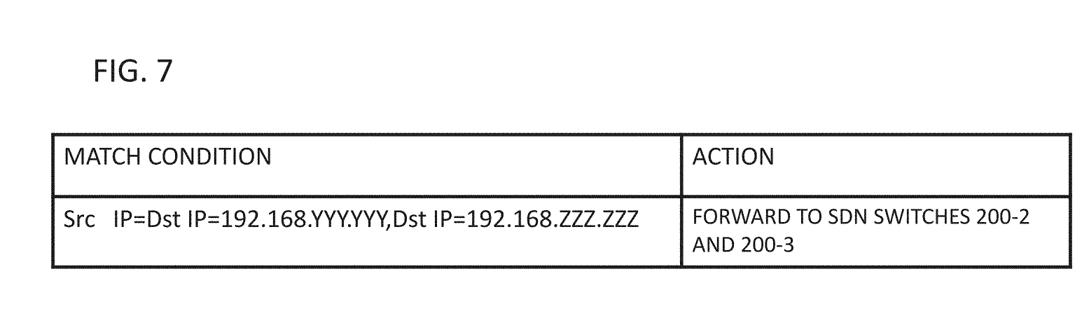

FIG. 7 shows an example of a flow entry created by the control apparatus proxy part 215 of the SDN switch. The example of FIG. 7 shows a flow entry that forwards a packet having a source IP address of 192.168.YYY.YYY and a destination IP address of 192.168.ZZZ.ZZZ to the SDN switches 200-2 and 200-3. There are two forwarding destination SDN switches because a single SDN switch does not calculate a path. Further, the SDN switches 200-2 and 200-3, the forwarding destinations, also create a flow entry based on the information of the packet for which the flow entry is created. As a result, the packet having the source IP address of 192.168.YYY.YYY and the destination IP address of 192.168.ZZZ.ZZZ is sent to the appropriate forwarding destination.

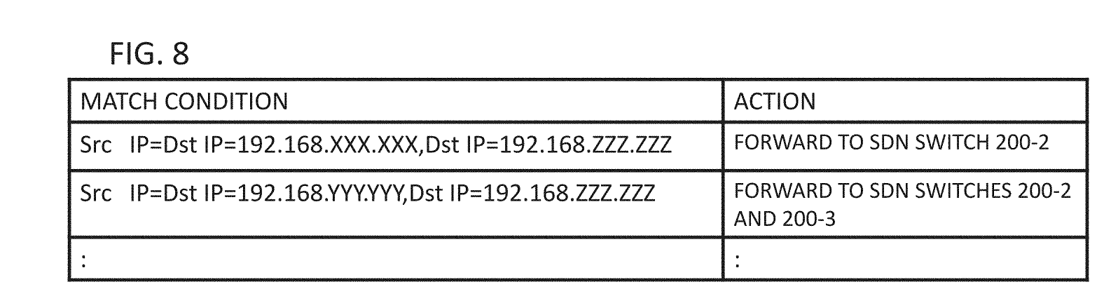

FIG. 8 is a drawing showing flow entries set in the flow table 214 of the SDN switch 200 of the first exemplary embodiment of the present disclosure. As shown in FIG. 8, the control apparatus proxy part 215 does not delete the flow entries set by the SDN controller 100 even in a state in which an abnormality in the connection with the SDN controller 100 is detected. As a result, it is possible to maintain the communication before an abnormality in the connection with the SDN controller 100 is detected (refer to the first flow entry in FIG. 8). The second flow entry in FIG. 8 is created by the control apparatus proxy part 215.

Further, the SDN switches 200-2 to 200-4 are configured identically and required VTN information is stored in the VTN information storage part 216 of each switch. Information for identifying flow entries created by the control apparatus proxy parts 215 of the SDN switches 200-2 to 200-4 is stored in the flow storage parts 217 of these SDN switches.

When the connection with the SDN controller is restored, the control apparatus proxy part 215 refers to the flow storage part 217 and deletes from the flow table 214 the flow entries created during the period when the connection with the SDN controller 100 was abnormal. This sends a request to the SDN controller 100 to recreate a flow entry and the SDN controller 100 sets a flow entry again. As a result, the centralized control by the SDN controller 100 is restarted.

Further, each part (processing means) of the SDN switch 200 shown in FIGS. 1 and 4 may be realized by a computer program having a computer that constitutes the SDN switch execute each processing described above using the hardware thereof.

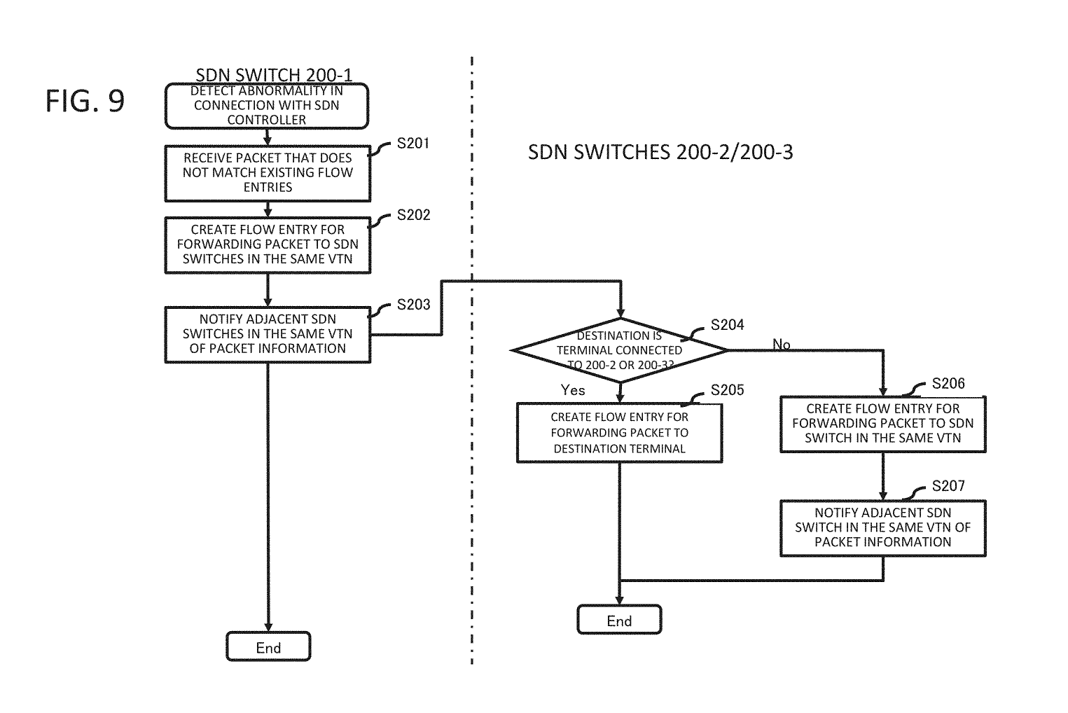

Next, the operation of the present exemplary embodiment will be described in detail with reference to the drawings. FIG. 9 is a flowchart showing the operation of the SDN switch of the first exemplary embodiment of the present disclosure. In the description below, it is assumed that the SDN switch 200-1 has detected an abnormality in the connection with the SDN controller and has received a new communication packet addressed to the user accommodation equipment 40-3 from the user accommodation equipment 40-1 in a state in which the control source is switched to the control apparatus proxy part 215. In FIG. 9, the SDN switch 200-1 searches for an entry matching the packet addressed to the user accommodation equipment 40-3 from the user accommodation equipment 40-1 in the flow table 214 (step S201).

When no entry having a match condition that matches the received packet is found in the flow table 214 as a result of the search, the SDN switch 200-1 asks the control apparatus proxy part 215 to create a flow entry for processing the packet as well as subsequent packets. The control apparatus proxy part 215 identifies the VTN based on the receive interface, etc., of the received packet. The control apparatus proxy part 215 refers to the VTN information shown in the upper part of FIG. 6 and creates a flow entry for forwarding the received packet to the SDN switches 200-2 and 200-3 (step S202; refer to FIG. 8).

Further, the SDN switch 200-1 notifies the SDN switches 200-2 and 200-3 that belong to the same VTN of the information of the packet received from the user accommodation equipment 40-1 (for instance the receive interface, L2 information, L3 information, and L4 information) (step S203).

The SDN switches 200-2 and 200-3 that have received the notification refer to the notified packet information and confirm whether or not the destination of the packet is a terminal in the user accommodation equipment connected to the SDN switch 200-2 or 200-3 (step S204). Note that whether or not the destination of the packet is a terminal in the user accommodation equipment connected to the SDN switch 200-2 or 200-3 can be determined by, for instance, referring to the connected terminal information held by the VTN information storage part 216 shown in the lower part of FIG. 6.

When the destination of the packet is confirmed to be a terminal in the user accommodation equipment connected to the SDN switch 200-2 or 200-3 (Yes in the step S204), the SDN switch 200-2 or 200-3 creates a flow entry for forwarding the packet to the destination terminal and sets it in the flow table 214 (step S205). For instance, the SDN switch 200-3 creates a flow entry for forwarding the packet transmitted by a terminal in the user accommodation equipment 40-1 to the user accommodation equipment 40-3 since the terminals in the user accommodation equipment 40-3 are connected to the SDN switch 200-3 in FIG. 3. As a result, the packet addressed to a terminal in the user accommodation equipment 40-3 from a terminal in the user accommodation equipment 40-1 can be forwarded without having the SDN controller 100 involved.

On the other hand, when the destination of the packet is confirmed not to be a terminal in the user accommodation equipment connected to the SDN switch 200-2 or 200-3 (No in the step 5204) and an SDN switch in the same VTN exists among adjacent SDN switches, the SDN switches 200-2 and 200-3 create a flow entry for forwarding the packet to this SDN switch (step S206). Further, the SDN switches 200-2 and 200-3 notify the SDN switch belonging to the same VTN of the packet information received from the user accommodation equipment 40-1 (step S207). By the cooperative operation of the communication nodes described above, the packet addressed to a terminal in the user accommodation equipment 40-3 from a terminal in the user accommodation equipment 40-1 can be forwarded without having the SDN controller 100 involved. Note that, since the SDN switch 200-2 does not have any adjacent SDN switch in the same VTN except for the SDN switch 200-1, which is the sender, in the examples of FIGS. 3 and 5, the flow entry is not created and the information of the received packet is not notified.

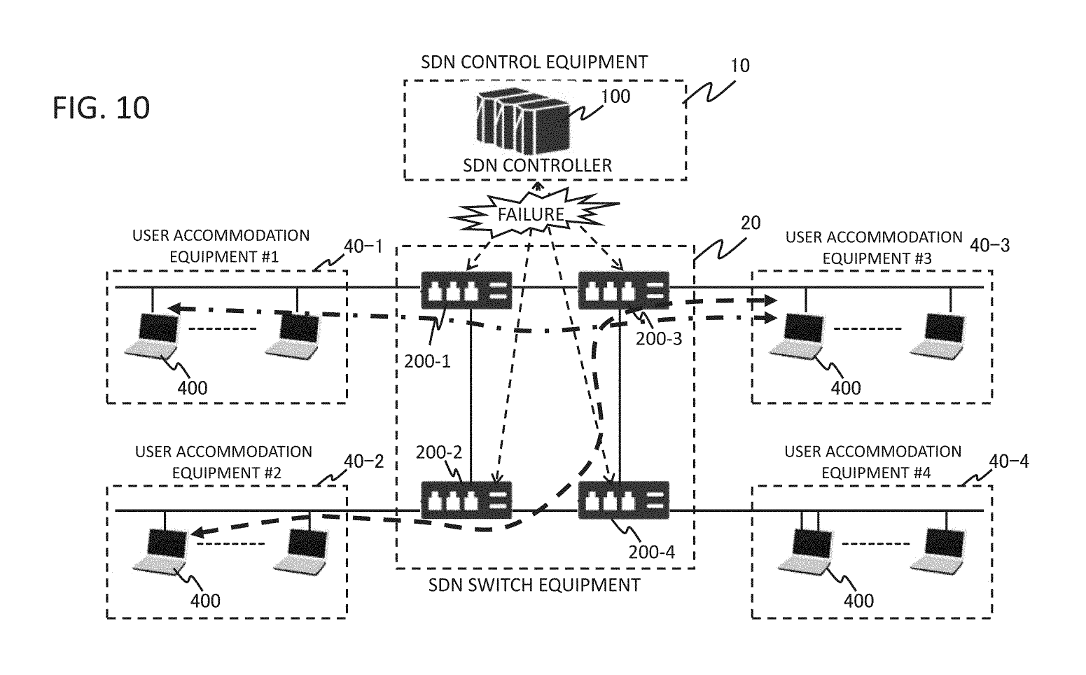

The SDN switch 200 continue the operation described above until it can receive an instruction from the SDN controller 100. As a result, as shown in FIG. 10, communication from a terminal in the user accommodation equipment 40-1 to a terminal in the user accommodation equipment 40-3 can be realized even when an abnormality occurs in the connection between the SDN switch 200 and the SDN controller 100 (refer to the two-sided arrow of the dash-dotted line in FIG. 10). Further, in the present exemplary embodiment, each SDN switch 200 continues to hold flow entries set by the SDN controller 100 without deleting them. As a result, communication is maintained by the flow entries set by the SDN controller 100 (refer to the two-sided arrow of the dashed line from the user accommodation equipment #2 (40-2) to the user accommodation equipment #3 (40-3) in FIG. 10).

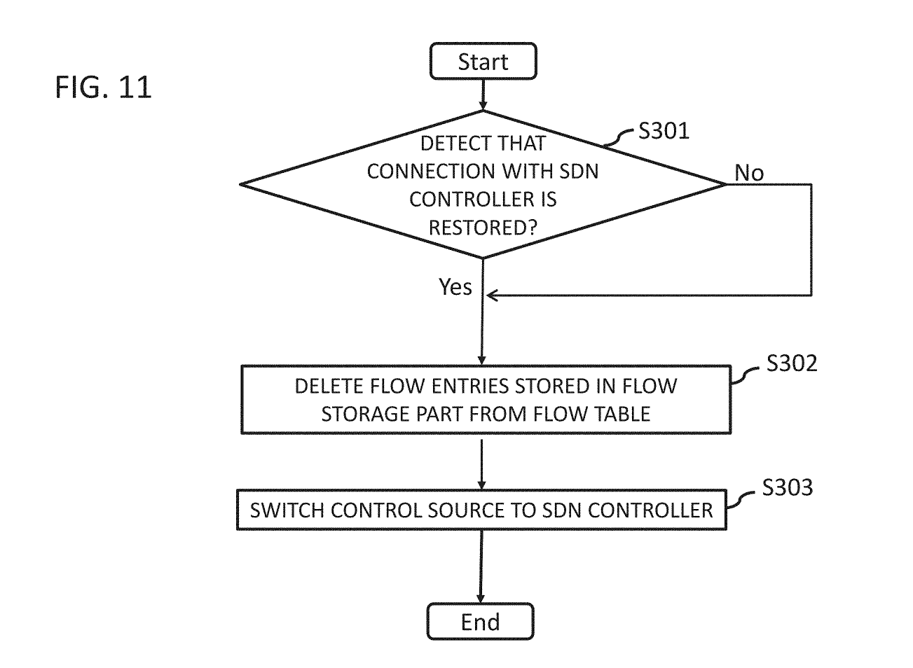

Next, the operation of the SDN switch when the connection between the SDN switch 200 and the SDN controller 100 is restored will be described. FIG. 11 is a flowchart showing the operation when the connection between the SDN switch 200 and the SDN controller 100 of the first exemplary embodiment of the present disclosure is restored.

In FIG. 10, when detecting that the connection with the SDN controller 100 is restored (Yes in step S301), the SDN switch 200 deletes flow entries stored in the flow storage part 217 from the flow table 214 (step S302). This will delete flow entries created by the control apparatus proxy part 215 of the SDN switch 200 during the period when the connectivity between the SDN switch 200 and the SDN controller 100 was abnormal.

Next, the SDN switch 200 switches the control source from the control apparatus proxy part 215 to the SDN controller 100 (step S303). When new communication occurs thereafter, the SDN switch 200 requests the SDN controller 100 to create a flow entry since a corresponding flow entry cannot be found in the flow table 214. When the SDN controller 100 creates a flow entry according to this request, the centralized control by the SDN controller 100 is restarted. For instance, the SDN switches 200-1 and 200-3 will delete the flow entry for realizing the communication between the user accommodation equipment 40-1 and the user accommodation equipment 40-3 in FIG. 10, however, consistency is maintained since the SDN controller 100 will create a new flow entry according to the request from the SDN switch 200-1.

As described above, according to the present exemplary embodiment, it becomes possible to not only maintain existing communication, but also establish new communication even when the SDN switch cannot receive an instruction from the SDN controller 100 in a centralized control network.

Further, in the exemplary embodiment described above, the SDN switch 200 deletes the flow entry set by itself when the connection between the SDN switch 200 and the SDN controller 100 is restored, however, the settings by the SDN switch 200 may be notified to the SDN controller 100.

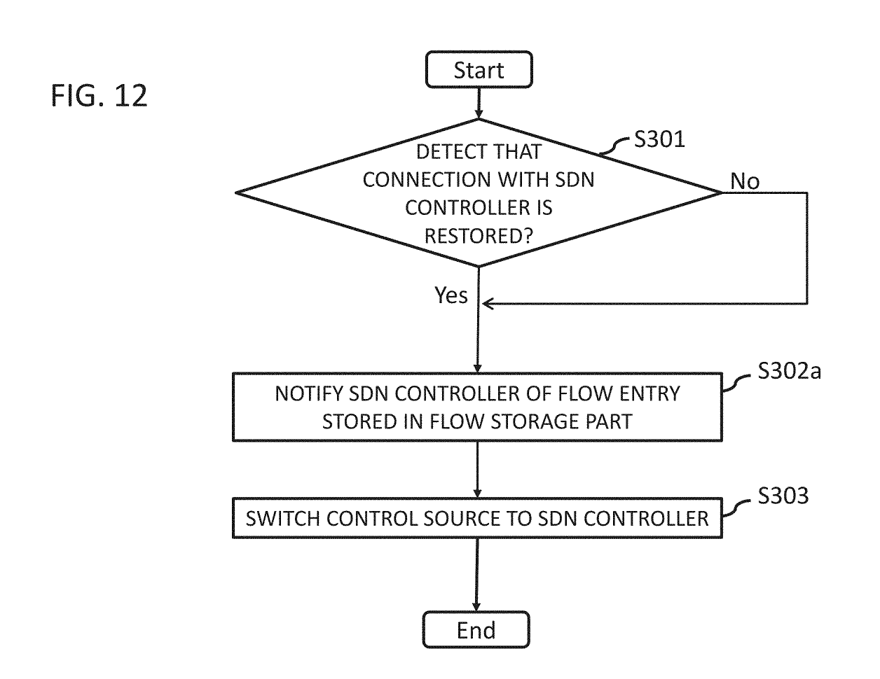

FIG. 12 is another flowchart showing the operation of the SDN switch when the connection is restored in the present disclosure. In FIG. 12, when detecting that the connection with the SDN controller 100 is restored (Yes in the step S301), the SDN switch 200 reads a flow entry stored in the flow storage part 217 and notifies the SDN controller 100 (step S302a). Then the SDN switch 200 switches the control source from the control apparatus proxy part 215 to the SDN controller 100 (the step S303).

The SDN controller 100, which has received the notification, has the notified flow entry reflected in flow management means (not shown in the drawing) thereof. Further, the SDN controller 100 may modify the flow entry set in each SDN switch 200 as necessary. As described, the SDN switch 200 may maintain consistency by notifying the SDN controller 100 of the flow entry created without any instruction from the SDN controller 100.

An exemplary embodiment of the present invention has been described, however, the present invention is not limited to the exemplary embodiment and further modifications, substitutions, and adjustments can be performed within the scope of the basic technological concept of the present invention. For instance, the network configurations, the configuration of each element, and the message expressions shown in each drawing are examples to facilitate understanding of the present invention and are not limited to what is shown in these drawings.

For instance, it is preferred that the SDN switches of the exemplary embodiment described above share information of the terminals connected to each SDN switch. In this case, the control apparatus proxy part 215 of the exemplary embodiment is able to calculate a path based on the VTN information stored in the VTN information storage part. As a result, it becomes possible to minimize packet duplication and unnecessary forwarding during the period when an instruction from the SDN controller cannot received.

Further, the communication node is an SDN switch and the control apparatus is an SDN controller in the exemplary embodiment described above, however, examples of the communication node and the control apparatus are not limited thereto. For instance, the communication node may be an OpenFlow switch and the control apparatus an OpenFlow controller.

Finally, preferred modes of the present invention will be summarized.

[Mode 1]

(Refer to the communication node according to the first aspect.)

[Mode 2]

The communication node can be configured to transmit information of packets belonging to the new communication to the other communication nodes and request the flow entry for realizing the new communication to be created when the new communication occurs.

[Mode 3]

The communication node can be configured to comprise a virtual network configuration storage part that stores configuration information of a virtual network to which the communication node belongs and have the control apparatus proxy part create a flow entry based on the configuration information of the virtual network.

[Mode 4]

It is preferred that the communication node have a function of deleting the flow entry set by the control apparatus proxy part in the flow table when a state in which an instruction from the predetermined control apparatus can be received is restored.

[Mode 5]

It is preferred that the communication node have a function of notifying the predetermined control apparatus of the contents of the flow entry set by the control apparatus proxy part in the flow table when a state in which an instruction from the control apparatus can be received is restored.

[Mode 6]

It is preferred that the communication node be configured to maintain existing communication without deleting a flow entry set by the predetermined control apparatus.

[Mode 7]

(Refer to the communication system according to the second aspect.)

[Mode 8]

(Refer to the communication method according to the third aspect.)

[Mode 9]

(Refer to the program according to the fourth aspect.)

Further, Modes 7 to 9 can be developed into Modes 2 to 6 as Mode 1.

Further, the disclosure of each Patent Literature cited above is incorporated herein in its entirety by reference thereto. It should be noted that other objects, features and aspects of the present invention will become apparent in the entire disclosure and that modifications may be done without departing the gist and scope of the present invention as disclosed herein and claimed as appended herewith. Also it should be noted that any combination of the disclosed and/or claimed elements, matters and/or items may fall under the modifications. Particularly, the ranges of the numerical values used in the present description should be interpreted as a numeric value or small range example included in these ranges even in cases where no explanation is provided.

### REFERENCE SIGNS LIST

10: SDN control equipment

20: SDN switch equipment

40-1 to 40-4: user accommodation equipment

100: SDN controller

100A: control apparatus

200, 200-1 to 200-4: SDN switch

200A to 200C: communication node

201: control part

202, 215: control apparatus proxy part

203, 214: flow table

204: packet processing part

211: SDN controller monitoring processing part

212: control message processing part

213: flow control part

216: VTN information storage part

217: flow storage part

300A, 300B: host

400: user terminal

What is claimed is:

1. A communication node comprising:
a flow table that stores a flow entry defining how a packet is processed;
a control part that updates the flow table according to an instruction from a predetermined control apparatus;
a packet processing part that processes a received packet by referring to the flow table; and
a control apparatus proxy part that creates a flow entry for realizing new communication in cooperation with control apparatus proxy parts of other communication nodes in place of the predetermined control apparatus when the new communication occurs in a state in which the instruction from the control apparatus cannot be received, wherein
the flow entry for realizing the new communication is set in the flow table so that packets belonging to the new communication can be processed until an instruction from the predetermined control apparatus can be received.

2. The communication node according to claim 1, wherein the communication node transmits information of packets belonging to the new communication to the other communication nodes and requesting the flow entry for realizing the new communication to be created when the new communication occurs.

3. The communication node according to claim 1, wherein the communication node further comprises a virtual network configuration storage part that stores configuration information of a virtual network to which the communication node belongs, wherein the control apparatus proxy part creates a flow entry based on the configuration information of the virtual network.

4. The communication node according to claim 1, wherein the communication node deletes the flow entry set by the control apparatus proxy part in the flow table when a state in which an instruction from the predetermined control apparatus can be received is restored.

5. The communication node according to claim 1, wherein the communication node notifies the predetermined control apparatus of the contents of the flow entry set by the control apparatus proxy part in the flow table when a state in which an instruction from the control apparatus can be received is restored.

6. The communication node according to claim 1, wherein the communication node maintains existing communication without deleting a flow entry set by the predetermined control apparatus in a state in which the instruction from the predetermined control apparatus cannot be received.

7. A communication system including:
a plurality of communication nodes comprising a flow table that stores a flow entry defining how a packet is processed, a control part that updates the flow table according to an instruction from a predetermined control apparatus, a packet processing part that processes a received packet by referring to the flow table, and a control apparatus proxy part that creates a flow entry for realizing new communication in cooperation with control apparatus proxy parts of other communication nodes in place of the predetermined control apparatus when the new communication occurs in a state in which the instruction from the control apparatus cannot be received, the communication nodes setting the flow entry for realizing the new communication in the flow table so that packets belonging to the new communication can be processed until an instruction from the predetermined control apparatus can be received; and
a control apparatus that instructs the plurality of communication nodes to update the flow tables.

8. A communication method including:
having a communication node comprising a flow table that stores a flow entry defining how a packet is processed, a control part that updates the flow table according to an instruction from a predetermined control apparatus, and a packet processing part that processes a received packet by referring to the flow table detect that the instruction from the predetermined control apparatus cannot be received; and
having the communication node create a flow entry for realizing new communication in cooperation with control apparatus proxy parts of other communication nodes in place of the predetermined control apparatus when the new communication occurs in a state in which the instruction from the control apparatus cannot be received, wherein
the flow entry for realizing the new communication is set in the flow table so that packets belonging to the new communication can be processed until an instruction from the predetermined control apparatus can be received.

9. A non-transitory computer-readable recording medium storing thereon a program having a computer installed in a communication node comprising a flow table that stores a flow entry defining how a packet is processed, a control part that updates the flow table according to an instruction from a predetermined control apparatus, and a packet processing part that processes a received packet by referring to the flow table execute:
a process of detecting that the instruction from the predetermined control apparatus cannot be received; and
a process of creating a flow entry for realizing new communication in cooperation with control apparatus proxy parts of other communication nodes in place of the predetermined control apparatus when the new communication occurs in a state in which the instruction from the control apparatus cannot be received, the program realizing a function of setting the flow entry for realizing the new communication in the flow table and processing packets belonging to the new communication until an instruction from the predetermined control apparatus can be received.

10. The communication node according to claim 2, wherein the communication node further comprises a virtual network configuration storage part that stores configuration information of a virtual network to which the communication node belongs, wherein the control apparatus proxy part creates a flow entry based on the configuration information of the virtual network.

11. The communication node according to claim 2, wherein the communication node deletes the flow entry set by the control apparatus proxy part in the flow table when a state in which an instruction from the predetermined control apparatus can be received is restored.

12. The communication node according to claim 3, wherein the communication node deletes the flow entry set by the control apparatus proxy part in the flow table when a state in which an instruction from the predetermined control apparatus can be received is restored.

13. The communication node according to claim 2, wherein the communication node notifies the predetermined control apparatus of the contents of the flow entry set by the control apparatus proxy part in the flow table when a state in which an instruction from the control apparatus can be received is restored.

14. The communication node according to claim 3, wherein the communication node notifies the predetermined control apparatus of the contents of the flow entry set by the control apparatus proxy part in the flow table when a state in which an instruction from the control apparatus can be received is restored.

15. The communication node according to claim 2, wherein the communication node maintains existing communication without deleting a flow entry set by the predetermined control apparatus in a state in which the instruction from the predetermined control apparatus cannot be received.

16. The communication node according to claim 3, wherein the communication node maintains existing communication without deleting a flow entry set by the predetermined control apparatus in a state in which the instruction from the predetermined control apparatus cannot be received.

17. The communication node according to claim 4, wherein the communication node maintains existing communication without deleting a flow entry set by the predetermined control apparatus in a state in which the instruction from the predetermined control apparatus cannot be received.

18. The communication node according to claim 5, wherein the communication node maintains existing communication without deleting a flow entry set by the predetermined control apparatus in a state in which the instruction from the predetermined control apparatus cannot be received.
